(19) United States
(12) Patent Application Publication
(10) Pub. No.: US 2015/0240917 A1
(43) Pub. Date: Aug. 27, 2015

(54) DRIVE TRAIN FOR A VEHICLE

(71) Applicant: AVL LIST GMBH, GRAZ (AT)

(72) Inventor: Jozef Karel Irma Vermeulen, New South Wales (AU)

(73) Assignee: AVL LIST GMBH, GRAZ (AT)

(21) Appl. No.: 14/423,593

(22) PCT Filed: Aug. 12, 2013
(86) PCT No.: PCT/EP2013/066812

§ 371 Date: Feb. 24, 2015

(30) Foreign Application Priority Data
Aug. 24, 2012 (AT) A 50340/2012

(51) Int. Cl. F16H 3/72; B60K 6/387; B60K 6/442

(52) U.S. Cl. CPC F16H 3/725; B60K 6/442; B60K 6/387; F16H 2200/2005; F16H 2200/2035; Y10S 903/91

(57) ABSTRACT

The invention relates to a drive train (1) for a vehicle, in particular an electric vehicle with a range extender, comprising a first electric machine (2) which is drivingly connected to at least one drive shall (8) of the vehicle by means of a planet gear (5) which comprises a first, second and third planet gear element (5a, 5b, 5c), also comprising a second electric machine (3) which is connected to the first electric machine (2) by means of the planet gear, and an internal combustion engine (4) which is connected to the first electric machine (2). A compact power train having a high degree of variability is thus produced such that a shiftable first clutch (9) is arranged between the internal combustion engine (4) and the second electric machine (3).

The invention relates to a drive train for a vehicle, especially an electric vehicle with a range extender, comprising a first electric machine which is drive-connected to at least one drive shaft of the vehicle by means of a planetary gear which comprises a first, second and third planetary gear element, and a second electric machine which is connected to the first electric machine via the planetary gear, and an internal combustion engine which is connected to the first electric machine.

U.S. Pat. No. 5,991,683 A discloses a drive train for a hybrid vehicle, comprising a first electric machine and a second electric machine, as well as an internal combustion engine, wherein the first electric machine is connected to a sun wheel of a planetary gear and the second electric machine is rigidly drive-connected to the planetary carrier of the planetary gear. The second electric machine is further rigidly drive-connected to an internal combustion engine, The ring gear of the planetary carrier acts on drive shafts of the vehicle, There are no clutch elements between the machines. This considerably limits the scope of application of the drive train, In particular, a decoupling of the second electric machine from the internal combustion engine or the planetary gear is not possible.

Further similar drive trains are known from the specifications EP 2 218 603 A1, US 2009/250,278 A, US 2010/006,357 A, U.S. Pat. No. 7,204,222 B, U.S. Pat. No. 6,991,054 B, U.S. Pat. No. 6,067,801 A, U.S. Pat. No. 6,161,640 A and U.S. Pat. No. 6,278,195 A,

It is therefore the object of the invention to provide a drive train which is suitable for use in hybrid vehicles with range extenders, wherein a temporary direct drive shall be possible via the range extender formed by an internal combustion engine. It shall also be possible to use the range extender briefly for supporting the electric drive. The drive train shall require as little space as possible,

This is achieved in accordance with the invention such a way that a shiftable first clutch is arranged between the internal combustion engine and the second electric machine, wherein preferably a shiftable second clutch is arranged between the second electric machine and the planetary gear,

The internal combustion engine can thus be decoupled from the second electric machine, as a result of which the second electric machine can be operated independently of the internal combustion engine for supporting recuperation work or for driving auxiliary units such as an air-conditioner compressor for example.

Since the second electric machine can be decoupled from the planetary gear by the second dutch, it is also possible to recharge the electric storage unit independently of the remaining drive train via the internal combustion engine and the second electric machine. Nevertheless, a drive connection to the remaining drive train can be produced by closing the first and second clutch, by means of which both the internal combustion engine and also the second machine can be used for supporting the drive power.

The first electric machine can be drive-connected to a first planetary gear element which is preferably formed by a ring gear. A second planetary gear element which is preferably formed by a planetary carrier acts on the drive shaft of the vehicle.

It is provided in a first embodiment of the invention that the second electric machine is connected to the second planetary gear element, The second electric machine and the internal combustion engine can be used directly for supporting the drive of the drive shaft. This allows shifting without interruption in the traction because the second electric machine can briefly provide the torque for the drive during the shifting process,

It is provided in a second embodiment of the invention that the second electric machine is connected to the first planetary gear element. In this process, the second electric machine and the internal combustion engine act on the same planetary gear element as the first electric machine. The drive of the vehicle is thus carried out by the internal combustion engine and the second electric machine via the speed-transforming transmission of the planetary gear. An especially high torque is provided in this manner. It is also possible as an alternative to provide the drive train in a more compact and lighter configuration because the drive torque is provided by the two electric machines.

At least two different gear steps can be realised in a simple manner when the first planetary gear element and the second planetary gear element are rigidly rotatably connectable to each other via a shiftable third clutch, wherein preferably the third planetary gear element that is preferably formed by a sun wheel is rigidly retainable by a braking device, Gear ratios of 1:1 or 1.5:1 for example can be enabled by selectively activating the third clutch and the brake element.

In order to enable the air-conditioning of the passenger compartment of the vehicle when the vehicle is static, it is especially advantageous if an air-conditioner compressor is drive-connected to the second electric machine, preferably via a transmission step.

The invention is explained below in closer detail by reference to the schematic drawings, wherein:

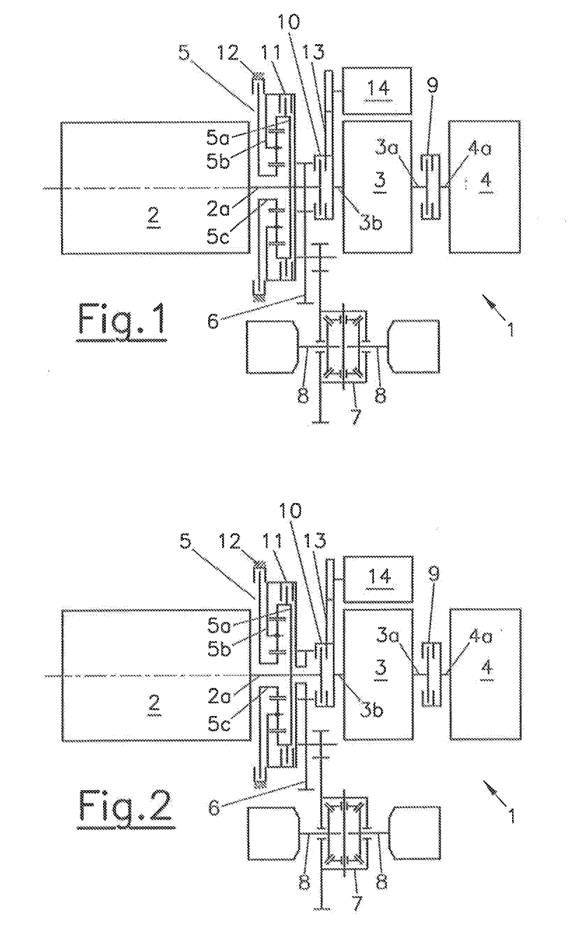

FIG. 1 shows a drive train in accordance with the invention in a first embodiment, and

FIG. 2 shows a drive train in accordance with the invention in a second embodiment.

The drawings show a drive train 1 for a hybrid vehicle, comprising a first electric machine 2, a second electric machine 3 and an internal combustion engine 4, which assumes—among other things—the function of a so-called range extender.

The first electric machine 2, which forms the primary drive source in the present example, acts via its drive shaft 2a on a first planetary gear element 5a of a planetary gear 5, said gear element being formed by a ring gear in the present embodiments. A second planetary gear element 5b, which is formed for example by a planetary carrier, is connected via a gear step 6 and a differential gear 7 to the drive shafts 8 of the vehicle.

The drive shaft 3a of the second electric machine 3 is connectable via a shiftable first clutch 9 to the shaft 4a of the internal combustion engine 4, On the side facing away from the internal combustion engine 4, the shaft 3b of the second electric machine 3 is connectable via a second clutch 10 to the planetary gear 5.

The first planetary gear element 5a and the second planetary gear element 5b of the planetary carrier can be rigidly connected to each other by means of a third clutch 11. The third planetary gear element 5c, which is formed by the sun wheel for example, can be retained by a braking device 12.

The drive shaft 3b of the second electric machine 3 is connected via a gear step 13 to an air-conditioner compressor 14.

In the embodiment shown in FIG. 1, the drive shaft 3b of the second electric machine 3 is connectable via the second clutch 10 to the second planetary gear element 5b, which acts directly via the gear step 6 having a rigid gear ratio and the differential gear 7 on the drive shafts 8. As a result, drive support can be realised by the second electric machine 3 and/or the internal combustion engine 4 at high speeds of the vehicle.

FIG. 2 shows an embodiment in which the drive shaft 3b of the second electric machine 3 is drive-connectable via the second clutch 10 to the first planetary gear element 5a of the planetary gear 5, The second electric machine 3 and/or the internal combustion engine 4 thus act on the input of the planetary gear 5—like the first electric machine 2—, by means of which the torque of the supporting second electric machine 3, which acts on the drive shaft S and the internal combustion engine 4, depends on the current gear ratio of the planetary gear 5 which depends on the shifting position of the third clutch 11 and the braking device 12.

The gear ratio of the planetary gear 5 can be changed by alternating activation and deactivation of the third clutch 11 and the braking device 12, wherein in the embodiment a gear ratio of 1:1 (direct power take-off) is obtained with activated third coupling 11 and deactivated braking device 12, and a gear ratio of 1.5:1 between the first planetary gear element 5a and the second planetary gear element 5b under deactivation of the third clutch 11 and activation of the braking device 12.

In the embodiment, the maximum torques of the first electric machine 2, the second electric machine 3 and the internal combustion engine 4 act at a ratio of 4:2:1.

The first clutch 9 is closed in order to start the internal combustion engine 4 and in order to charge the electric energy storage unit when the internal combustion engine 4 is activated. The first clutch 9 may also be closed when torque support is desired or required for acceleration by the internal combustion engine 4.

The second clutch 10 is closed when the second electric machine 3 is activated for supporting the acceleration or recuperation, The second clutch 10 is opened when the internal combustion engine 4 is used as a range extender only for charging the electric energy storage unit. The rotor of the second electric machine 3 can form the flywheel for the internal combustion engine 4 in this process.

The internal combustion engine 4 forming the range extender is thus part of the drive train 1 and forms a compact system together with the two electric machines 2, 3, which system only requires one set of damping and insulation, The range extender can be used both for charging the electric battery storage unit and also for applying additional torque, e.g. during a shifting process of the primary drive machine.

Both electric machines 2, 3 can be used for recuperation. Each component of the drive train 1 can be activated or deactivated independently.

The described drive system 1 thus represents a highly compact arrangement for a hybrid vehicle with range extender and provides a large number of different potential applications.

1-9. (canceled)

10. A drive train for a vehicle, comprising a first electric machine which is drive-connected to at least one drive shaft of the vehicle by means of a planetary gear which comprises a first, second and third planetary gear element, and a second electric machine which is connected to the first electric machine via the planetary gear, and an internal combustion engine which is connected to the first electric machine, wherein the first electric machine is connected to the first planetary gear element and the drive shaft to the second planetary gear element, and wherein a shiftable first clutch is arranged between the internal combustion engine and the second electric machine, wherein the second electric machine is connected to the first planetary gear element or the second planetary gear element.

11. The drive train according to claim 10, including a shiftable second clutch between the second electric machine and the planetary gear.

12. The drive train according to claim 10, wherein the first planetary gear element comprises a ring gear.

13. The drive train according to claim 10, wherein the second planetary gear element comprises a planetary carrier.

14. The drive train according to claim 10, wherein the first planetary gear element and the second planetary gear element are rotatably rigidly connected to each other by a shiftable third clutch.

15. The drive train according to claim 10, wherein the third planetary gear element is retained by a braking device.

16. The drive train according to claim 15, wherein the third planetary gear element comprises a sun wheel.

17. The drive train according to claim 10, including an auxiliary unit drive-connected to the second electric machine by a gear step.

18. The drive train according to claim 17, wherein said auxiliary unit comprises an air conditioner compressor.
